(19) United States
(12) Patent Application Publication
(10) Pub. No.: US 2016/0185128 A1
(43) Pub. Date: Jun. 30, 2016

(54) LARGE CUBOID SHAPED OBJECT INKJET PRINTING

(71) Applicant: AGFA GRAPHICS NV, Mortsel (BE)

(72) Inventors: Tom CLOOTS, Mortsel (BE); Joseph VANDER AA, Mortsel (BE); Luc BOUWENS, Mortsel (BE)

(21) Appl. No.: 14/911,740

(22) PCT Filed: Sep. 1, 2014
(86) PCT No.: PCT/EP2014/068459

§ 371 Date: Feb. 12, 2016

(30) Foreign Application Priority Data
Sep. 12, 2013 (EP) 13184029.0

(51) Int. Cl. B41J 3/407; B41J 2/045

(52) U.S. Cl. CPC B41J 3/4073; B41J 2/04505; B41J 2/04586

(57) ABSTRACT

A method of UV curable inkjet printing on a cuboid shaped object includes the steps of jetting and UV curing an image of one or more UV curable inks on at least one vertical panel of the cuboid shaped object, and measuring the perpendicular distance from an active distance controller to the vertical plane, wherein the cuboid shaped object is selected from intermodal freight containers, crates, trucks, trailers, semi-trailers and boxcars.

### CROSS-REFERENCE TO RELATED APPLICATIONS

This application is a 371 National Stage Application of PCT/EP2014/068459, filed Sep. 1, 2014. This application claims the benefit of European Application No. 13184029.0, filed Sep. 12, 2013, which is incorporated by reference herein in its entirety.

### BACKGROUND OF THE INVENTION

1. Field of the Invention

The present invention relates to inkjet printing on large cuboid shaped objects such as intermodal freight containers, trucks and railway cars.

2. Description of the Related Art

Intermodal containerized traffic has surged since the 1990s to ship products on international and national markets, particularly for non bulk commodities. “Intermodal” means that the container can be moved from one mode of transport to another, e.g. from ship to rail to truck, without unloading and reloading the contents of the container.

The manufacturing of intermodal freight containers is well-known. Generally, the containers are made of metal and their assembly involves the production and welding of flat or corrugated metal panels. Newer techniques involve moulding thermoplastic material into a container as exemplified by US 2010264137 (LAMPE). In a finishing stage of the manufacturing process, the container is painted by spraying solvent based paint. The painting includes the application of a primer, the application of background paint, and the application of company logo and text information, such as an owner code, container identification code, product group code, maximum weight, container weight, cubic capacity and the like. The application of the primer and the application of the background paint is usually by an automatic paint spray device as shown in, for example, CN 101480643 (CIMC). The painting of a company logo and text information is performed by applying adhesive masks of the logo and alphanumerical characters on a container panel, followed by spraying paint on the inside of the mask. This painting process is very time-consuming, especially if multiple colours are required, and leads also often to errors in applying the masks, causing expensive re-painting and additional loss of time.

In an attempt to increase productivity, the masks were replaced by adhesive decorative films pre-printed with the required logo and/or alphanumerical characters, usually so-called decals. This method caused a significant reduction of errors in the alphanumerical data. However, due to corrugated panels used in container for increasing the strength of a container, the films were often applied askew. EP 2108515 A (BOEING) discloses an apparatus for application and accurate positioning of a graphic image on a large contoured surface, comprising a flexible-rail positioning system mounted on a portion of the surface on which the graphic image is to be applied.

In addition, it was observed that after time that some of the adhesive markings disappeared from the container panels due to weathering conditions, conditions of transport (including the exposure to sea-water and traffic emissions) and vandalism. US 2010316853 A (AIRBUS) discloses the spraying of an aircraft with a layer of clear paint containing a UV filter for erosion protection of the decorative film.

Hence, there is a still a need for an improved method of applying logos, safety messages and alphanumerical information on large cuboid shaped objects such as intermodal freight containers.

### SUMMARY OF THE INVENTION

In order to overcome the problems described above, preferred embodiments of the present invention have been realised with an inkjet printing method as defined below.

The printing method using UV curable ink and UV curing provides for higher productivity by a simplification of the workflow to manufacture intermodal freight containers, thereby making it also a more economical process.

An advantage of the inkjet printing method is that variable data and images can be printed on each large cuboid shaped object. This allows generating extra income for container manufacturers that can sell the large surface for long-lasting advertisements. In addition the alphanumerical data is controlled by a computer which almost eliminates errors in, for example, the owner code or the container identification codes, such as bar-codes and QR-codes.

Further advantages and benefits of the invention will become apparent from the description hereinafter.

### BRIEF DESCRIPTION OF THE DRAWINGS

FIG. 1 shows state-of-the-art cuboid shaped intermodal freight containers.

FIG. 2 shows a three dimensional view of a standard container skeleton 6.

FIG. 3 shows an exploded view of a standard container.

FIG. 4 shows examples of large cuboid shaped objects: a truck 25, a trailer 26, a semi-trailer 27 and a boxcar 28.

FIG. 5 shows a cross-section of a corrugated surface 29 of a container being printed using a rail 30 with protrusions 31 as a passive distance controller so that the print head in a first position 32 and the print head in a second position 33 are at approximately the same distance of the corrugated surface 29.

FIG. 6 shows a cross-section of a corrugated surface 29 of a container being printed using an active distance controller 35 so that the print head in a first position 32 and the print head in a second position 33 are at approximately the same distance of the corrugated surface 29.

FIG. 7 shows a preferred embodiment for printing a corrugated surface 29 using a print head array 37 of a plurality of individual print heads 36.

FIG. 8 shows a preferred embodiment for printing a corrugate surface 29,103 of a cuboid shaped object 101 by rotating 2 part of a nozzle rows 104 to equalize the distance between nozzles 105 and vertical panel.

FIG. 9 shows a preferred embodiment for printing a corrugate surface 29,103 of a cuboid shaped object 101 by rotating the UV inkjet head module to equalize the distance between nozzles 105 and vertical panel.

FIG. 10 shows a preferred embodiment wherein the UV inkjet head module (102) is moved horizontal and vertical to jet an image on a cuboid shaped object 101 with a movable horizontal printing bridge 111. The UV inkjet head module 102 is mounted on a base 110 whereon an active distance controller is attached to measure the distance between the UV inkjet printer and the vertical panel and an alignment device are attached (not in the image) to align the printing plane of the inkjet printing device and the vertical panel to be parallel based on the measuring of the active distance controller.

FIG. 11 shows a preferred embodiment wherein the UV inkjet head module 102 is moved horizontal and vertical to jet an image on a cuboid shaped object 101 with a multiaxis application robot 112. The UV inkjet head module 102 is mounted on a base 110 whereon an active distance controller is attached to measure the distance between the UV inkjet printer and the vertical panel and an alignment device are attached (not in the image) to align the printing plane of the inkjet printing device and the vertical panel to be parallel based on the measuring of the active distance controller.

FIG. 12 shows a preferred embodiment wherein the UV inkjet head module 102 is moved horizontal and vertical to jet an image on a cuboid shaped object 101 with a movable vertical printing bridge 111. The UV inkjet head module 102 is mounted on a base 110 whereon an active distance controller is attached to measure the distance between the UV inkjet printer and the vertical panel and an alignment device are attached (not in the image) to align the printing plane of the inkjet printing device and the vertical panel to be parallel based on the measuring of the active distance controller.

FIG. 13 shows a preferred embodiment wherein the UV inkjet head module 102 is moved horizontal and vertical to jet an image on a cuboid shaped object 101 with a movable horizontal printing bridge 111 and multiaxis application robot 112. The UV inkjet head module 102 is mounted on a base 110 whereon an active distance controller is attached to measure the distance between the UV inkjet printer and the vertical panel and an alignment device are attached (not in the image) to align the printing plane of the inkjet printing device and the vertical panel to be parallel based on the measuring of the active distance controller.

FIG. 14 shows a preferred embodiment wherein the UV inkjet head module 102 is moved horizontal and vertical to jet an image on a cuboid shaped object 101 with a movable horizontal printing bridge 111 and telescopic arm. The UV inkjet head module 102 is mounted on a base 110 whereon an active distance controller is attached to measure the distance between the UV inkjet printer and the vertical panel and an alignment device are attached (not in the image) to align the printing plane of the inkjet printing device and the vertical panel to be parallel based on the measuring of the active distance controller.

FIG. 15 shows a preferred embodiment wherein the UV inkjet head module 102 is moved horizontal and vertical to jet an image on a cuboid shaped object 101 with a vertical moving telescopic arm. The UV inkjet head module 102 is mounted on a base 110 whereon an active distance controller is attached to measure the distance between the UV inkjet printer and the vertical panel and an alignment device are attached (not in the image) to align the printing plane of the inkjet printing device and the vertical panel to be parallel based on the measuring of the active distance controller.

FIG. 16 shows the configuration of a preferred embodiment wherein the UV inkjet head module 102 comprises an anti-static device 120, inkjet heads with nozzle rows 104 and nozzles 105. After the UV inkjet head module an air-knife is attached to flatten the jetted ink and/or drip-preventing the ink before curing with the curing device 123.

### DETAILED DESCRIPTION OF THE PREFERRED EMBODIMENTS

### Definitions

The term “image” includes text, numbers, graphics, logo's, photo's, identification codes (codes such as barcodes, QR codes, and the like) and the like. An image can be defined in 1 or more colours.

The term “inkjet ink set”, as used in disclosing the present invention means the inkjet ink set which is coupled to the inkjet printing device.

### UV Curable Inkjet Printing Methods

The method of UV curable inkjet printing on a vertical panel of a cuboid shaped object according to the present invention includes the steps of measuring the perpendicular distance from an active distance controller to the vertical plane and jetting an image with a set of UV curable inks of an inkjet printing device wherein the cuboid shaped object is selected from intermodal freight containers, crates, trucks, trailers, semi-trailers and boxcars. In a preferred embodiment, the cuboid shaped object is an intermodal freight container and in a more preferred embodiment, the cuboid shaped object is an intermodal freight container following the specifications of ISO 668:1995 and in a most preferred embodiment, the cuboid shaped object is an intermodal freight container following the specification of ISO 668:2013.

For achieving good image quality the plane wherein the UV inkjet head module is moving in front of the vertical panel have to be parallel with the vertical plane. More preferably the UV curable inkjet printing method comprises an alignment step by using the measurement of the active distance controller to move the UV inkjet head module parallel with the vertical plane.

The technology behind active distance controllers is well-known to the skilled person. For example, ultrasonic sensors are used in a PDC (Parking Distance Control) system for helping a driver to park his car. Active distance control systems using laser or laser diodes are used also in a radar apparatus like disclosed by U.S. Pat. No. 5,864,391 (DENSO) or in speed guns. In a preferred embodiment of the UV curable inkjet printing method, the active distance controller uses an ultrasonic sensor, infrared sensor or photoelectric distance sensor, also called distance measuring photoelectric sensor. A distance measuring photoelectric sensors provide a dynamic continuous analogue output signal, in some cases a digital output can be activated as well, that relates to object position. These sensors emit either a visible red or preferably a laser light that reflects back to the sensor.

In a further preferred embodiment the measuring of the perpendicular distance from an active distance controller is measured at a corner of the vertical panel, such as the corner fitting 9, more preferably at 2 corners of the panel and most preferably at 3 corners of the panel. Another preferred embodiment the measuring of the perpendicular distance from an active distance controller is measured to the side of the panel such as the top side rail 8, top end rail, bottom end rail, bottom side rail.

In a preferred embodiment the method of the UV curable inkjet printing is a contact-less printing method so the UV inkjet head module can easily maintained and is independent the shape of the cuboid shaped object.

Bring part of the inkjet printing device before the vertical panel is preferably accomplished by sliding it before the vertical plane, by riding it on wheels towards the vertical plane or by swinging it towards the vertical plane.

The attachment device of the UV inkjet head module is preferably adjustable in X, Y and Z direction for optimal alignment of the inkjet printing device with the vertical panel.

When the vertical panel is not completely flat but has, for example, a corrugated surface, then the distance between an inkjet nozzle and the surface of the at least one vertical panel is controlled by an other active distance controller or a passive distance controller.

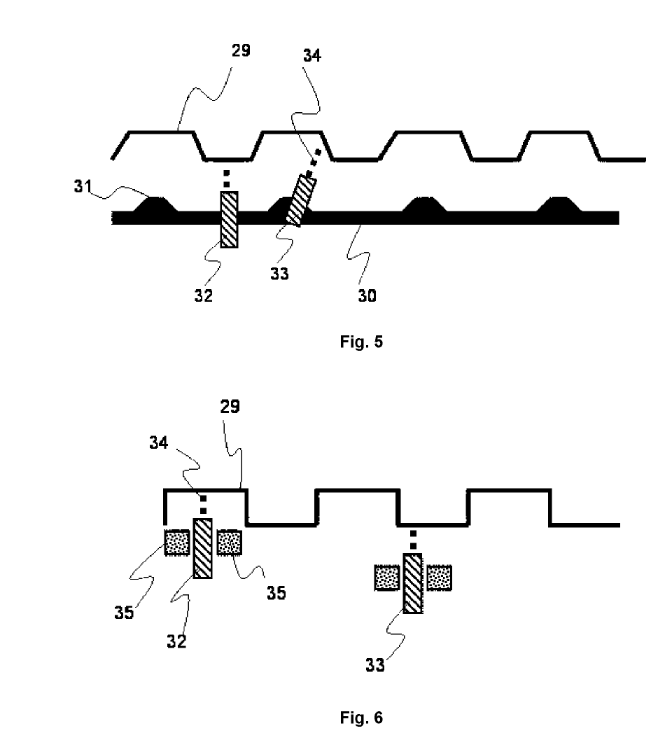

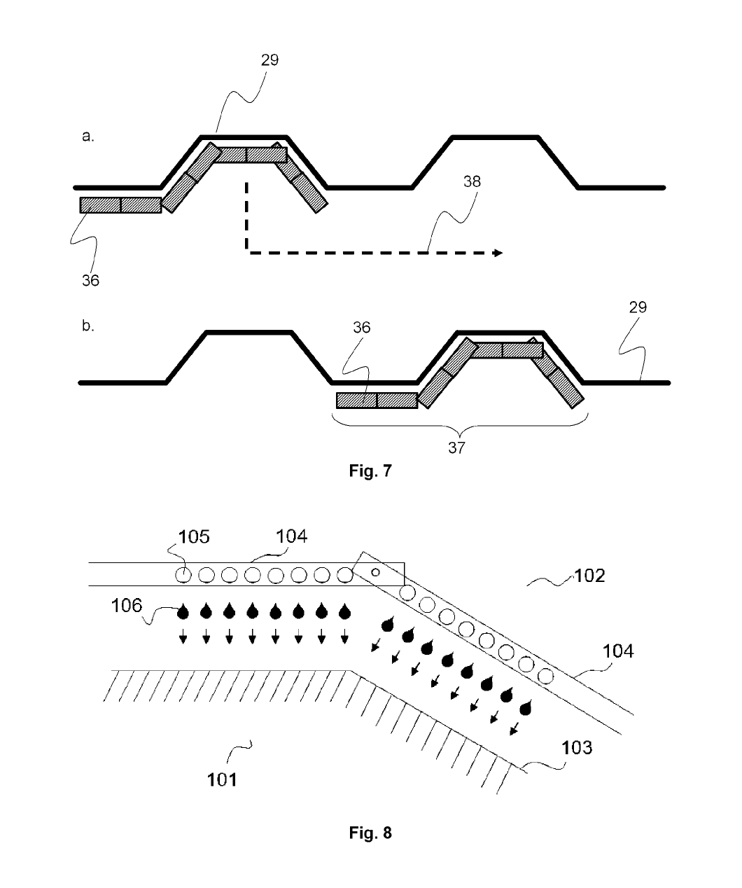

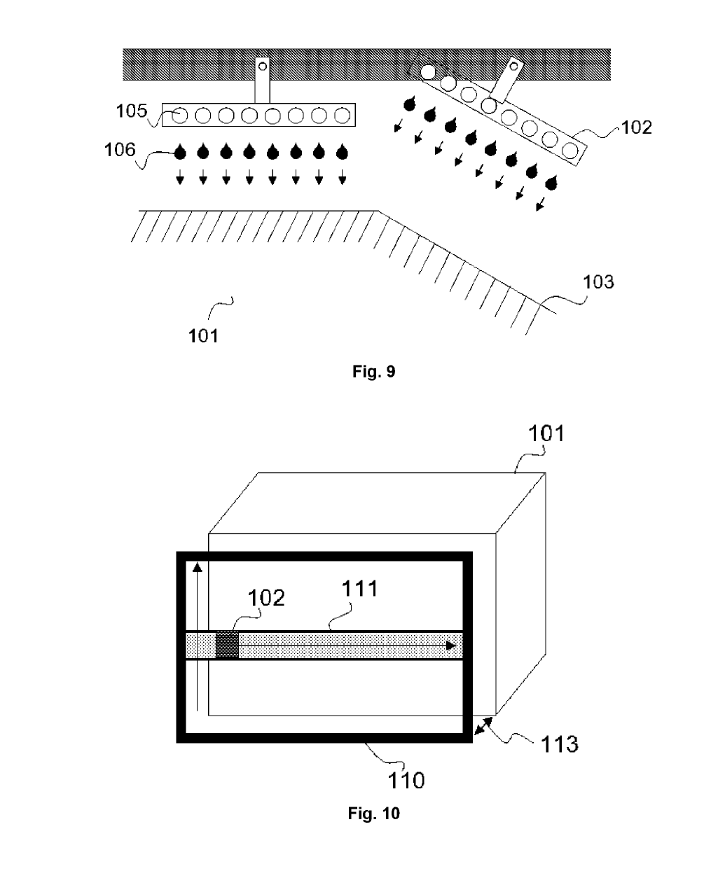

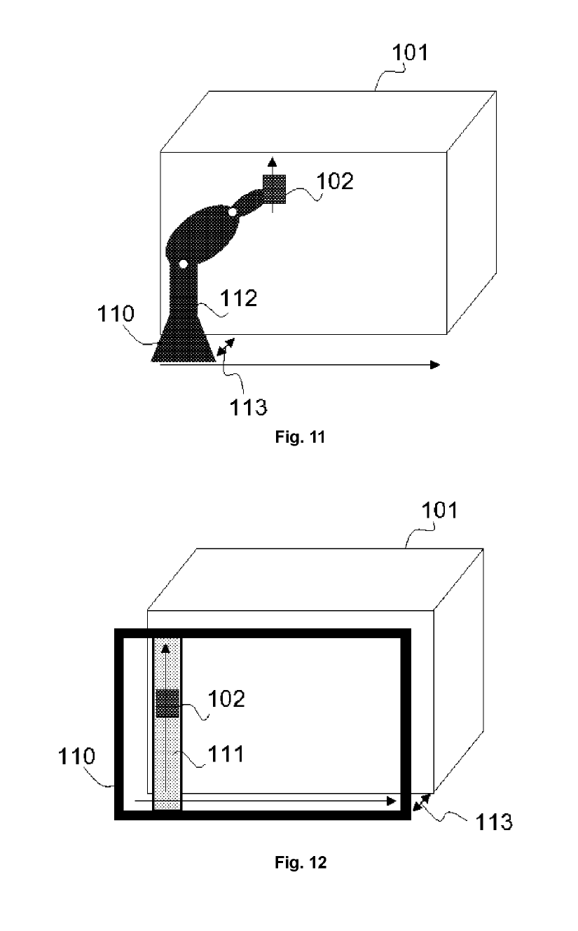

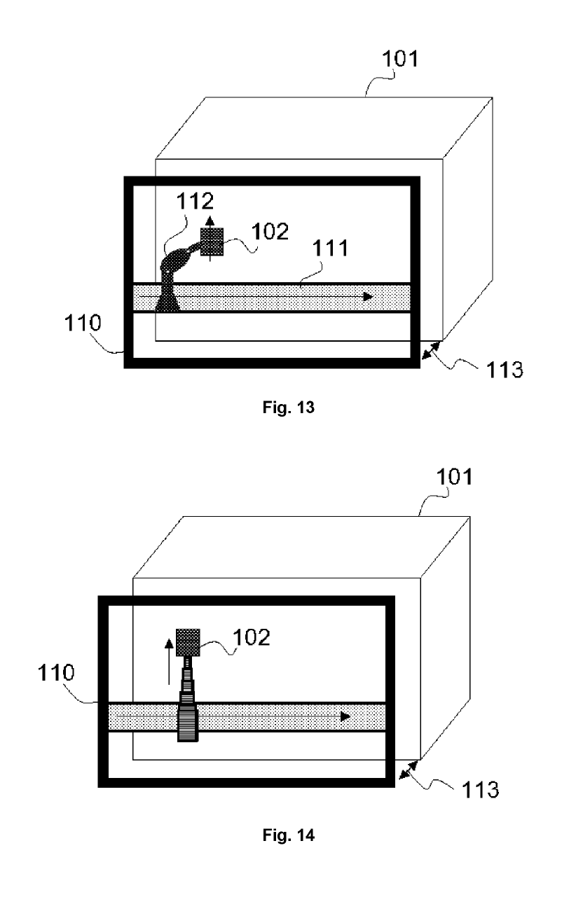

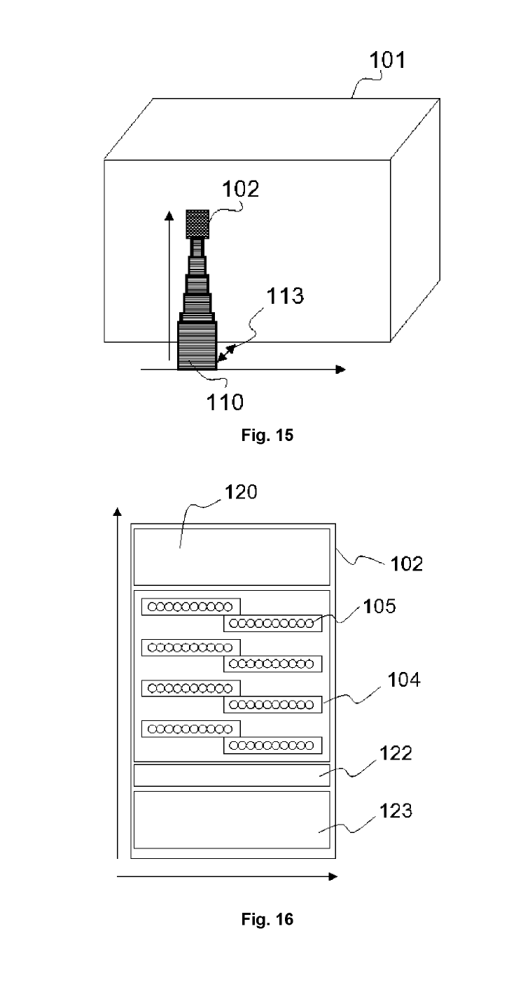

Alternatively a passive distance controller may be used. A passive distance controller is a fixed device, such as a rail 30 with protrusions 31 as shown in FIG. 5, which matches the relief of a vertical panel so that minimal distance variations are obtained between the inkjet nozzle and the surface of the at least one vertical panel as a print head travels across the rail 30. Preferably, the rail with protrusions is easily replaceable, so that vertical panels with a differently corrugated surface can be printed with the same inkjet printing device. An active distance controller has the advantage over a passive distance controller that differently shaped vertical panels e.g. with and without a corrugated surface can be inkjet printed upon without the necessity to replace the passive distance controller by a differently shaped passive distance controller.

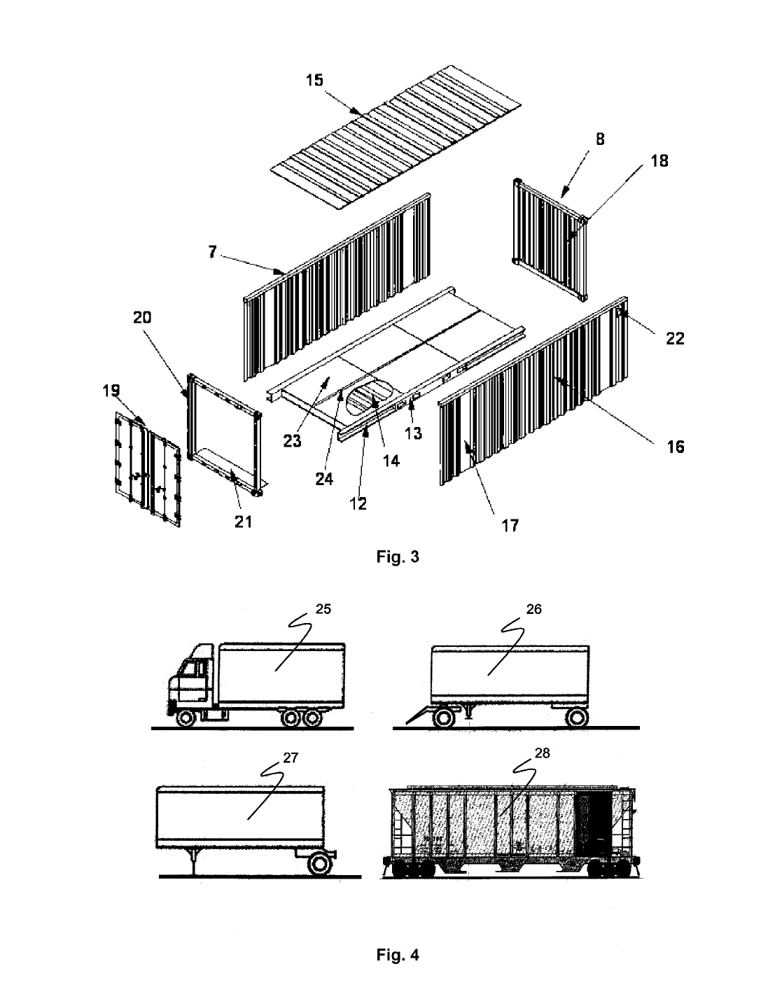

In the UV curable inkjet printing method, the image is preferably jetted and cured simultaneously on at least two vertical panels of the cuboid shaped object. For example, the image is preferably jetted and cured simultaneously on both sidewall panels 16 of the container shown in FIG. 3.

Preferably also an image is jetted and cured on the horizontal roof panel. Such an image may consist of the container identification code, which can be useful for the operator of a straddle carrier. In a more preferred embodiment, the image on the roof panel is jetted and cured simultaneously with both sidewall panels 16 of a container as shown in FIG. 3.

### Cuboid Shaped Objects

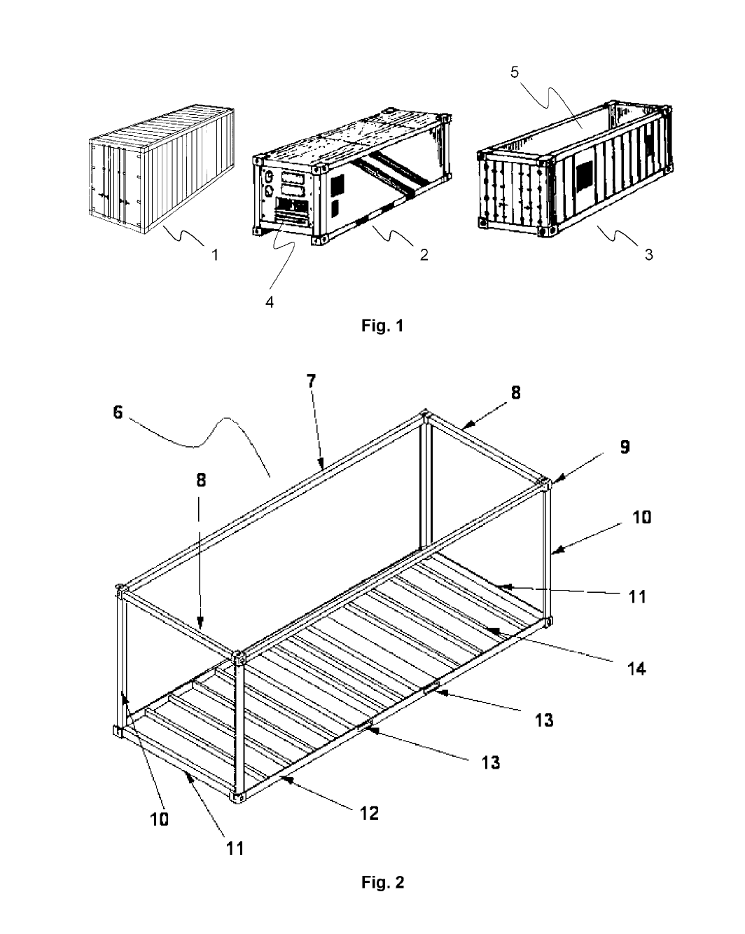

The cuboid shaped object is selected from intermodal freight containers, crates, trucks, trailers, semi-trailers and boxcars. In a preferred embodiment, the cuboid shaped object is an intermodal freight container, preferably a refrigerated container or reefer 2 including a refrigeration unit 4 as shown in FIG. 1.

FIG. 1 merely shows some examples of an intermodal freight containers, such as a standard container 1, a reefer 2 and an open-top container 3. Most parts of an intermodal freight container and their assembly are shown in FIGS. 2 and 3.

Another preferred cuboid shaped object is a crate, which is a container made of wood for storage or as a shipping container.

Other preferred cuboid shaped objects are a truck 25, a trailer 26, a semi-trailer 27 and a boxcar 28. A boxcar is also known as a cargo railway car.

The intermodal freight container preferably has as external dimensions a length between 5.5 m and 13.8 m, a width of about 2.4 m and a height between 2.2 m and 2.9 m.

The large cuboid shaped object preferably has an internal volume exceeding 1 m³, preferably exceeding 3 m³ and preferably exceeding 10 m³.

Since at present no cuboid shaped intermodal freight container having a UV cured inkjet image on a vertical panel is known or thought of, a preferred embodiment of the current invention includes a method of manufacturing a cuboid shaped intermodal freight container comprising the above described inkjet printing method.

The vertical panel may be a corrugated panel. In a preferred embodiment, the corrugation is preferably less than 5 mm deep, so that printing speed can be maximized, more preferably no corrugation is present. This latter preferred option can be achieved, for example, by having a corrugated side wall panel covered by a flat plate. In this manner, both the physical strength of the container due to the corrugation and the image quality due to a flat surface can be maximized simultaneously.

### UV Curable Inks

One or more UV curable inks are jetted and UV cured by the inkjet printing device on the cuboid shaped object.

The one or more UV curable inks are preferably free radical curable inks. It was found that cationically curable inkjet inks posed problems of jetting reliability in industrial inkjet printing systems due to UV stray light. UV stray light hitting nozzles may result into failing nozzles due to clogging by cured ink in a nozzle. Unlike free radical ink where radical species have a much shorter lifetime, the cationic curable ink continues to cure once an acid species has been generated by UV light in the nozzle.

The UV curable inkjet ink is preferably part of a UV curable inkjet ink set. Such a curable ink set preferably includes at least one cyan curable ink (C) and at least one magenta curable ink (M), at least one yellow curable ink (Y), and preferably also at least one black curable ink (K). The curable CMYK-ink set may also be extended with extra inks such as red, green, blue, and/or orange to further enlarge the colour gamut. The CMYK ink set may also be extended by the combination of the full density inkjet inks with light density inkjet inks. The combination of dark and light colour inks and/or black and grey inks improves the image quality by a lowered graininess.

In a preferred embodiment, the one or more UV curable inkjet inks include a spot colour inkjet ink. In a more preferred embodiment the spot colour inkjet inks has a colour selected from the group consisting of RAL 1033, RAL 2000, RAL 2002, RAL 2004, RAL 3003, RAL 3005, RAL 3009, RAL 5003, RAL 5010, RAL 5013, RAL 5015, RAL 6002, RAL 6005, RAL 6013, RAL 6017, RAL 6018, RAL 7000, RAL 7031, RAL 7035, RAL 7037, RAL 7038, RAL 8004, RAL 8012, and RAL 9010.

In a preferred embodiment, the one or more UV curable inks include a white ink. This allows masking the colour of primers and paints and allows for more vibrant colours from the more UV curable inks.

In a preferred embodiment, the one or more UV curable inkjet inks form an ink set of 4 to 6 UV curable inkjet inks.

The UV curable inkjet ink set may be made using four inkjet inks having a colour selected from the group consisting of RAL 1033, RAL 2000, RAL 2002, RAL 2004, RAL 3003, RAL 3005, RAL 3009, RAL 5003, RAL 5010, RAL 5013, RAL 5015, RAL 6002, RAL 6005, RAL 6013, RAL 6017, RAL 6018, RAL 7000, RAL 7031, RAL 7035, RAL 7037, RAL 7038, RAL 8004, RAL 8012, and RAL 9010.

In a preferred embodiment of the UV curable inkjet printing method, the UV curable inkjet ink set may be mixed from a basis UV curable inkjet set with an ink mixing station. This enables the possibility to jet an image on each cuboid shaped object with different UV curable inkjet ink set. The ink mixing station may mix the basis UV curable inkjet set to an ink with a colour selected from the group consisting of RAL 1033, RAL 2000, RAL 2002, RAL 2004, RAL 3003, RAL 3005, RAL 3009, RAL 5003, RAL 5010, RAL 5013, RAL 5015, RAL 6002, RAL 6005, RAL 6013, RAL 6017, RAL 6018, RAL 7000, RAL 7031, RAL 7035, RAL 7037, RAL 7038, RAL 8004, RAL 8012, and RAL 9010.

However preferably the UV curable inkjet ink set includes at least one cyan curable ink (C) and at least one magenta curable ink (M), at least one yellow curable ink (Y), and preferably also at least one black curable ink (K). The curable CMYK-ink set may also be extended with extra inks such as the above mentioned spot colours. Using CMYK inks allows not only for a much larger colour gamut but also allows the use of conventional colour management systems used in graphic arts applications.

The static surface tension of the UV curable inkjet ink is preferably from 20 to 40 mN/m, more preferably from 22 to 35 mN/m. It is preferably 20 mN/m or more from the viewpoint of printability by a second radiation curable inkjet ink, and it is preferably not more than 30 mN/m from the viewpoint of the wettability. Therefore, the one or more UV curable inkjet inks preferably also contain at least one surfactant.

UV curable inkjet inks used in traditional graphic arts applications normally have a viscosity at a shear rate of 1,000 s⁻¹ and at 25° C. which is smaller than 30 mPa·s, often smaller than 15 mPa·s. For printing vertical panels of large cuboid shaped objects, the viscosity is preferably higher than 40 mPa·s at a shear rate of 1,000 s⁻¹ and at 25° C. A low viscosity requires a very high power UV curing, since else the jetted ink would run down the vertical surface. Using higher viscosity ink in combination with suitable print heads allows to reduce the cost of the UV curing device. For maximizing printing speed, the viscosity is preferably not higher than 600 mPa·s at a shear rate of 1,000 s⁻¹ and at 25° C.

In one preferred embodiment, the one or more UV curable inks are one or more UV curable phase change inks. UV curable phase change inks are solid at room temperature but become liquid at higher jetting temperatures. This behaviour can be advantageously used for improving image quality. A UV curable phase change inkjet ink solidifies on landing on a vertical panel having room temperature and the run down of ink is minimized. UV curable phase change inkjet inks are well-known to skilled person. Such inks are exemplified in, for example, US 2012224011 (XEROX) and US 2008122914 (XEROX).

### Primers and Paints

The chemical nature of the primers and paints may differ from the UV curable inks. For example, they may be solvent based, because the requirements for the application of primers and paints are less demanding than those for the image wise application of UV curable inks.

The primers and paints may have a colour selected from the group consisting of RAL 1033, RAL 2000, RAL 2002, RAL 2004, RAL 3003, RAL 3005, RAL 3009, RAL 5003, RAL 5010, RAL 5013, RAL 5015, RAL 6002, RAL 6005, RAL 6013, RAL 6017, RAL 6018, RAL 7000, RAL 7031, RAL 7035, RAL 7037, RAL 7038, RAL 8004, RAL 8012, and RAL 9010.

In a preferred embodiment of the UV curable inkjet printing method, a primer is applied to a vertical panel before jetting the image. The primer normally includes some protective components such as anti-rust compounds. Such components often limit the number of colours wherein a primer is available. Therefore preferably a paint having the desired colour is sprayed on the primed vertical panel before jetting an image with the one or more UV curable inks.

### Colorants

The colorant in the UV curable inkjet ink can be a dye but is preferably a colour pigment for reasons of light fading. The pigmented UV curable ink preferably contains a dispersant, more preferably a polymeric dispersant, for dispersing the pigment. The pigmented curable ink may contain a dispersion synergist to improve the dispersion quality and stability of the ink.

The pigments may be black, cyan, magenta, yellow, red, orange, violet, blue, green, brown, mixtures thereof, and the like. A colour pigment may be chosen from those disclosed by HERBST, Willy, et al. Industrial Organic Pigments, Production, Properties, Applications. 3rd edition. Wiley—VCH, 2004. ISBN 3527305769.

Preferred pigments are disclosed in paragraphs [0128] to [0138] of WO 2008/074548 (AGFA). Also mixed crystals may be used. Mixed crystals are also referred to as solid solutions. For example, under certain conditions different quinacridones mix with each other to form solid solutions, which are quite different from both physical mixtures of the compounds and from the compounds themselves. In a solid solution, the molecules of the components enter into the same crystal lattice, usually, but not always, that of one of the components. The x-ray diffraction pattern of the resulting crystalline solid is characteristic of that solid and can be clearly differentiated from the pattern of a physical mixture of the same components in the same proportion. In such physical mixtures, the x-ray pattern of each of the components can be distinguished, and the disappearance of many of these lines is one of the criteria of the formation of solid solutions. A commercially available example is Cinquasia™ Magenta RT-355-D from Ciba Specialty Chemicals.

Mixtures of pigments may also be used. For example, the UV curable inkjet ink may include a black pigment and at least one pigment selected from the group consisting of a blue pigment, a cyan pigment, magenta pigment and a red pigment. It was found that such a black inkjet ink allowed easier and better colour management and also gave a more pleasing neutral black colour instead of a brownish black colour.

Instead of organic colour pigments, also inorganic colour pigments may be used.

Particularly preferred inorganic colour pigments are infrared reflective pigments. The advantage of using such pigments is that less heat is transferred into the intermodal freight containers, trucks and boxcars, leading to a longer shelf-life of the contents in the containers. Using infrared reflective pigments also reduces the energy consumption by reefers.

The infrared reflective pigments can also be blended with organic colour pigments.

Suitable commercially available infrared reflective pigments are Altiris™ pigments from Huntsman and Arctic™ infrared-reflective pigments from Shepherd Color Company.

Pigment particles in inkjet inks should be sufficiently small to permit free flow of the ink through the inkjet printing device, especially at the ejecting nozzles. It is also desirable to use small particles for maximum colour strength and to slow down sedimentation.

Pigment particles of 4 to 15 μm can be used for producing single colours, however for producing a plurality of colours with the UV curable inkjet inks, the numeric average pigment particle size is preferably between 0.050 and 1 μm, more preferably between 0.070 and 0.300 μm and particularly preferably between 0.080 and 0.200 μm. Most preferably, the numeric average pigment particle size is no larger than 0.200 μm. An average particle size smaller than 0.050 μm is less desirable for decreased light fastness. An average pigment particle size is larger than 0.200 μm reduces the colour gamut. The average particle size of pigment particles is determined with a Brookhaven Instruments Particle Sizer BI90plus based upon the principle of dynamic light scattering. The ink is diluted with ethyl acetate to a pigment concentration of 0.002 wt %. The measurement settings of the BI90plus are: 5 runs at 23° C., angle of 90°, wavelength of 635 nm and graphics=correction function.

However for white pigment inkjet inks, the numeric average particle diameter of the white pigment is preferably from 50 to 500 nm, more preferably from 150 to 400 nm, and most preferably from 200 to 350 nm. Sufficient hiding power cannot be obtained when the average diameter is less than 50 nm, and the storage ability and the jet-out suitability of the ink tend to be degraded when the average diameter exceeds 500 nm.

The determination of the average particle size (the numeric average particle diameter) is best performed by photon correlation spectroscopy at a wavelength of 633 nm with a 4 mW HeNe laser on a diluted sample of the pigmented inkjet ink. A suitable particle size analyzer used was a Malvern™ nano-S available from Goffin-Meyvis. A sample can, for example, be prepared by addition of one drop of ink to a cuvette containing 1.5 mL ethyl acetate and mixed until a homogenous sample was obtained. The measured particle size is the average value of 3 consecutive measurements consisting of 6 runs of 20 seconds.

Suitable white pigments are given by Table 2 in [0116] of WO 2008/074548 (AGFA). The white pigment is preferably a pigment with a refractive index greater than 1.60. The white pigments may be employed singly or in combination. Preferably titanium dioxide is used as pigment with a refractive index greater than 1.60. Preferred titanium dioxide pigments are those disclosed in [0117] and in [0118] of WO 2008/074548 (AGFA).

The pigments are preferably present in the range of 3.0 wt % to 20.0 wt %.

### Dispersants

The pigmented radiation curable inkjet ink preferably contains a dispersant, more preferably a polymeric dispersant, for dispersing the pigment. The pigmented radiation curable inkjet ink may contain a dispersion synergist to improve the dispersion quality and stability of the inkjet ink.

Suitable polymeric dispersants are copolymers of two monomers but they may contain three, four, five or even more monomers. The properties of polymeric dispersants depend on both the nature of the monomers and their distribution in the polymer. Copolymeric dispersants preferably have the following polymer compositions:

statistically polymerized monomers (e.g. monomers A and B polymerized into ABBAABAB);

alternating polymerized monomers (e.g. monomers A and B polymerized into ABABABAB);

gradient (tapered) polymerized monomers (e.g. monomers A and B polymerized into AAABAABBABBB);

block copolymers (e.g. monomers A and B polymerized into AAAAABBBBBB) wherein the block length of each of the blocks (2, 3, 4, 5 or even more) is important for the dispersion capability of the polymeric dispersant;

graft copolymers (graft copolymers consist of a polymeric backbone with polymeric side chains attached to the backbone); and

mixed forms of these polymers, e.g. blocky gradient copolymers.

Suitable polymeric dispersants are listed in the section on “Dispersants”, more specifically [0064] to [0077], in EP 1911814 A (AGFA).

The polymeric dispersant has preferably a number average molecular weight Mn between 500 and 30000, more preferably between 1500 and 10000.

The polymeric dispersant has preferably a weight average molecular weight Mw smaller than 100,000, more preferably smaller than 50,000 and most preferably smaller than 30,000.

The polymeric dispersant has preferably a polydispersity PD smaller than 2, more preferably smaller than 1.75 and most preferably smaller than 1.5.

Particularly preferred commercially available polymeric dispersants include Solsperse™ dispersants from NOVEON, Efka™ dispersants from CIBA SPECIALTY CHEMICALS INC and Disperbyk™ dispersants from BYK CHEMIE GMBH.

The polymeric dispersant is preferably used in an amount of 2 to 600 wt %, more preferably 5 to 20 wt %, most preferably 50 to 90 wt % based on the weight of the pigment.

Suitable dispersion synergists that are commercially available include Solsperse™ 5000 and Solsperse™ 22000 from NOVEON.

Suitable dispersion synergists include also those disclosed in EP 1790698 A (AGFA), EP 1790696 A (AGFA), WO 2007/060255 (AGFA) and EP 1790695 A (AGFA).

In a preferred embodiment, the dispersion synergist includes one, two or more carboxylic acid groups.

### Photoinitiators and Co-Initiators

The UV curable inkjet inks preferably also contains one or more photoinitiators and optionally co-initiators.

The photoinitiator in the radiation curable inkjet inks is preferably a free radical initiator, more specifically a Norrish type I initiator or a Norrish type II initiator. A free radical photoinitiator is a chemical compound that initiates polymerization of monomers and oligomers when exposed to actinic radiation by the formation of a free radical. A Norrish Type I initiator is an initiator which cleaves after excitation, yielding the initiating radical immediately. A Norrish type II-initiator is a photoinitiator which is activated by actinic radiation and forms free radicals by hydrogen abstraction from a second compound that becomes the actual initiating free radical. This second compound is called a polymerization synergist or co-initiator. Both type I and type II photoinitiators can be used in the present invention, alone or in combination.

Suitable photoinitiators are disclosed in CRIVELLO, J. V., et al. VOLUME III: Photoinitiators for Free Radical Cationic. 2nd edition. Edited by BRADLEY, G. London, UK: John Wiley and Sons Ltd, 1998. p. 287-294.

Specific examples of photoinitiators may include, but are not limited to, the following compounds or combinations thereof: benzophenone and substituted benzophenones, 1-hydroxycyclohexyl phenyl ketone, thioxanthones such as isopropylthioxanthone, 2-hydroxy-2-methyl-1-phenylpropan-1-one, 2-benzyl-2-dimethylamino-(4-morpholinophenyl) butan-1-one, benzil dimethylketal, bis(2,6-dimethylbenzoyl)-2,4,4-trimethylpentylphosphine oxide, 2,4,6trimethylbenzoyldiphenylphosphine oxide, 2-methyl-1-[4-(methylthio)phenyl]-2-morpholinopropan-1-one, 2,2-dimethoxy-1,2-diphenylethan-1-one or 5,7-diiodo-3-butoxy-6-fluorone.

Suitable commercial photoinitiators include Irgacure™ 184, Irgacure™ 500, Irgacure™ 907, Irgacure™ 369, Irgacure™ 1700, Irgacure™ 651, Irgacure™ 819, Irgacure™ 1000, Irgacure™ 1300, Irgacure™ 1870, Darocur™ 1173, Darocur™ 2959, Darocur™ 4265 and Darocur™ ITX available from CIBA SPECIALTY CHEMICALS, Lucerin™ TPO available from BASF AG, Esacure™ KT046, Esacure™ KIP150, Esacure™ KT37 and Esacure™ EDB available from LAMBERTI, H-Nu™ 470 and H-Nu™ 470X available from SPECTRA GROUP Ltd.

A preferred amount of photoinitiator is 1-50 wt %, more preferably 3-20 wt %, and most preferably 5-15 wt % of the total weight of the curable ink.

The radiation curable inkjet inks preferably includes the co-initiator in an amount of 1 to 50 wt %, more preferably in an amount of 2 to 25 wt %, most preferably in an amount of 3 to 10 wt % of the total weight of the inkjet ink.

### Polymerization Inhibitors

The radiation curable inkjet inks may contain a polymerization inhibitor. Suitable polymerization inhibitors include phenol type antioxidants, hindered amine light stabilizers, phosphor type antioxidants, hydroquinone monomethyl ether commonly used in (meth)acrylate monomers, and hydroquinone, t-butylcatechol, pyrogallol may also be used.

Suitable commercial inhibitors are, for example, Sumilizer™ GA-80, Sumilizer™ GM and Sumilizer™ GS produced by Sumitomo Chemical Co. Ltd.; Genorad™ 16, Genorad™ 18 and Genorad™ 20 from Rahn AG; Irgastab™ UV10 and Irgastab™ UV22, Tinuvin™ 460 and CGS20 from Ciba Specialty Chemicals; Floorstab™ UV range (UV-1, UV-2, UV-5 and UV-8) from Kromachem Ltd, Additol™ S range (S100, S110, S120 and S130) from Cytec Surface Specialties.

Since excessive addition of these polymerization inhibitors will lower the ink sensitivity to curing, it is preferred that the amount capable of preventing polymerization is determined prior to blending. The amount of a polymerization inhibitor is preferably lower than 2 wt % of the total inkjet ink.

### Polymerizable Compounds

Any polymerizable compound commonly known in the art may be employed.

Preferably a monomer or oligomer capable of free radical polymerization is used as polymerizable compound. A combination of monomers, oligomers and/or prepolymers may also be used. The monomers, oligomers and/or prepolymers may possess different degrees of functionality, and a mixture including combinations of mono-, di-, tri- and higher functionality monomers, oligomers and/or prepolymers may be used. The viscosity of the radiation curable compositions and inks can be adjusted by varying the ratio between the monomers and oligomers.

Preferred monomers and oligomers are those listed in [0106] to [0115] in EP 1911814 A (AGFA).

### Other Additives and Topcoats

One or more UV curable inks may further contain one or more other additives, such as stabilizers, crosslinking agents, plasticizers, special pigments and spacing agents.

Preferred stabilizers are anti-light fading agents for maximal color retention. Instead of including the stabilizers in the UV curable inks, preferably a topcoat, a so-called varnish, is applied on the cured UV curable inks. For example, a top coat, such as silicone alkyd enamel (e.g. Silkyd™-7010 from SIMCO), may be used in order to obtain a tough, resilient coating having exceptional exterior durability with superior gloss and color retention. The topcoat may also provide protection against sea-water. Suitable protective topcoats include alkyd alkoxy silanes and silixones. For example, a topcoat of DuPont™ StoneTech™ Professional Salt Water Resistant Sealer can be applied.

Preferred light stabilizers are benzophenones, benztriazole compounds and HALS-compounds.

The topcoat preferably includes hard particles, such as silica and aluminum oxides, for protection against wear.

### Surfactants

The radiation curable inkjet ink may contain at least one surfactant. The surfactant can be anionic, cationic, non-ionic, or zwitter-ionic and is preferably added in a total quantity less than 3 wt % based on the total weight of the ink and particularly in a total less than 1 wt % based on the total weight of the inkjet ink.

Preferred surfactants are selected from fluoro surfactants (such as fluorinated hydrocarbons) and silicone surfactants. The silicone surfactants are preferably siloxanes and can be alkoxylated, polyester modified, polyether modified, polyether modified hydroxy functional, amine modified, epoxy modified and other modifications or combinations thereof. Preferred siloxanes are polymeric, for example polydimethylsiloxanes.

Preferred commercial silicone surfactants include BYK™ 333 and BYK™ UV3510 from BYK Chemie.

In a preferred embodiment, the surfactant is a polymerizable compound.

Preferred polymerizable silicone surfactants include a (meth)acrylated silicone surfactant. Most preferably the (meth)acrylated silicone surfactant is an acrylated silicone surfactant, because acrylates are more reactive than methacrylates.

In a preferred embodiment, the (meth)acrylated silicone surfactant is a polyether modified (meth)acrylated polydimethylsiloxane or a polyester modified (meth)acrylated polydimethylsiloxane.

Preferred commercially available (meth)acrylated silicone surfactants include: Ebecryl™ 350, a silicone diacrylate from Cytec; the polyether modified acrylated polydimethylsiloxane BYK™ UV3500 and BYK™ UV3530, the polyester modified acrylated polydimethylsiloxane BYK™ UV3570, all manufactured by BYK Chemie; Tego™ Rad 2100, Tego™ Rad 2200N, Tego™ Rad 2250N, Tego™ Rad 2300, Tego™ Rad 2500, Tego™ Rad 2600, and Tego™ Rad 2700, Tego™ RC711 from EVONIK; Silaplane™ FM7711, Silaplane™ FM7721, Silaplane™ FM7731, Silaplane™ FM0711, Silaplane™ FM0721, Silaplane™ FM0725, Silaplane™ TM0701, Silaplane™ TM0701T all manufactured by Chisso Corporation; and DMS-R05, DMS-R11, DMS-R18, DMS-R22, DMS-R31, DMS-U21, DBE-U22, SIB1400, RMS-044, RMS-033, RMS-083, UMS-182, UMS-992, UCS-052, RTT-1011 and UTT-1012 all manufactured by Gelest, Inc.

### Preparation of UV Curable Inkjet Inks

The preparation of radiation curable inkjet inks is well-known to the skilled person. Preferred methods of preparation are disclosed in paragraphs [0076] to [0085] of WO 2011/069943 (AGFA).

### UV Inkjet Head Module

The inkjet printing device comprises an UV inkjet head module comprising one or more print heads, with one or more nozzle rows, which jets the UV curable inkjet inks by ejecting small droplets in a controlled manner through nozzles onto the vertical panel, which is moving relative to the print head(s).

The inkjet print head normally scans back and forth in a transversal direction across the moving ink-receiver surface. Bi-directional printing, also called multi-pass printing, is preferred for obtaining a high areal throughput. Another preferred printing method is by a “single pass printing process”, which can be performed by using page wide inkjet print heads or multiple staggered inkjet print heads which cover the entire width of the ink receiver-surface or the vertical panel.

In a multi-pass printing method such as shingling and interlacing as exemplified by EP 1914668 (AGFA-GEVAERT) or print masks method as exemplified by U.S. Pat. No. 7,452,046 (HEWLETT-PACKARD), the method of the UV curable inkjet printing is preferably using a anti-drip print mask method so in a pass of printing the jetted ink is prevented to drip down from the vertical panel. Previous cured ink layers from previous passes may prevent the drip of jetted ink before curing. Preferably the anti-drip print masks are print-masks with chess-board-patterns and/or horizontal line patterns.

A preferred print head for the inkjet printing system is a so-called valve jet print head. Preferred valve jet print heads have a nozzle diameter between 45 and 600 μm. This allows for a resolution of 15 to 150 dpi which is preferred for having high productivity while not comprising image quality.

The way to incorporate valve jet print heads into an inkjet printing device is well-known to the skilled person. For example, US 2012105522 (MATTHEWS RESOURCES INC) discloses a valve jet printer including a solenoid coil and a plunger rod having a magnetically susceptible shank.

Suitable commercial valve jet print heads are chromoJET™ 200, 400 and 800 from Zimmer and Printos™ P16 from VideoJet.

In a preferred embodiment of the UV curable inkjet printing method, the inkjet printing device includes one or more valve jet print heads. The print head preferably jets droplets of 1 to 1500 nanoliter, which is much more than the picoliter droplets used jetted most piezoelectric or thermal inkjet printing systems.

In a preferred embodiment, the resolution of the valve jet print head is 15 to 150 dpi, preferably the resolution is no more than 75 dpi, more preferably no more than 50 dpi for maximizing printing speed and productivity.

Valve-jet printheads allowing variable dots or an UV Inkjet head module with valve-jet print heads with different resolutions can also be advantageously used to enhance image quality further.

The throwing distance of the UV curable inkjet ink droplets is preferably between 3 and 50 mm, more preferably between 5 and 30 mm for maximizing image quality. The throwing distance corresponds to the distance between an inkjet nozzle and the surface of the at least one vertical panel.

In a preferred embodiment, the jetting by the print head is performed in an upwards direction. In this manner, an already cured ink droplet inhibit excessive run down of an ink droplet jetted above the already cured ink droplet.

A preferred inkjet printing device used for printing a corrugated surface 29 includes a print head array 37 of a plurality of individual print heads 36. The inkjet printing is then performed by moving the print head array for jetting in a top-down, preferably in a down-top movement, followed by horizontal step movement 38 an repeating the top-down and/or down-top printing movement. The individual printheads 36 are positioned in such a manner that they match the corrugated surface so that a constant distance between the inkjet nozzles and the corrugated surface is accomplished.

Furthermore, the print heads at both ends of the print head array are preferably positioned in a manner that there is a small overlap of the printing zones before and after a horizontal step movement.

In another preferred embodiment, a single print head whereof the shape of the print head matches the relief of part of the corrugated surface.

Preferably print heads are used that have a small dead edge, i.e. the area at the edge of the nozzle plate lacking nozzles. Such printheads allow that printing can be performed in the corners of the corrugated surface.

A preferred embodiment of the UV inkjet printing method comprises a method by adapting the timing of firing ink droplets to correct print defects caused by the relief of the vertical panel so the ink droplets land at the appropriate location on the vertical panel by checking a topological map of the relief of the vertical panel. The topological map may be produced by an active distance controller that has scanned the vertical panel or may be produced by rendering the three-dimensional content defined in a three-dimensional vector drawing format that defines the relief of the cuboid shaped object or preferably the relief of the vertical panel. An example of an ink jet printing method on a flat table with such a droplet throw distance correction, also called landing distance correction point, is disclosed in US20070070099 (APPLIED MATERIALS).

### Inkjet Printing Device

The inkjet printing device, also called an inkjet printer, to print an image on a vertical panel of a cuboid shaped object is called a cuboid shaped object inkjet printing device or a cuboid shaped object inkjet printer.

In a preferred embodiment of the cuboid shaped object inkjet printing device comprises a base to move an UV inkjet head module, attached to the base, in front of the vertical panel. The inkjet head module is capable of moving in a first direction (X) by a first movement device attached to the base and is capable of moving in a second direction (Y), perpendicular to the first direction (X) by a second movement device attached to the base. So the UV inkjet head module moves in a plane formed by the first direction (X) and the second direction (Y), also called the printing plane. Preferably the moving in the first direction and/or second direction of the UV inkjet head module is performed by linear movement devices attached to the base.

The base of the cuboid shaped object inkjet printing device may move the UV inkjet head module in a third direction (Z), which is perpendicular to the plane formed by the first direction (X) and the second direction (Y) to align the printing plane to be parallel with the plane wherein the vertical panel is positioned, also called the vertical panel plane. The vertical panel plane may be defined by three corners of the vertical panel. Preferably the moving in the third direction is performed by a movement device attached to the base. The movement device may rotate and/or translate the base to move the UV inkjet head module in the third direction (Z). The aligning is preferably based on a measurement of an active distance controller attached to the base that measure the distance from the active distance controller to the vertical panel and more preferably based on two measurements of two different active distance controllers attached to the base and most preferably based on three measurements of three different active distance controllers attached to the base.

A preferred embodiment of the cuboid shaped object inkjet printing device comprises a control unit that controls the movement devices attached to the base unit, such as the first linear movement device, the second linear movement device, the alignment device that controls the movement in the third direction (Z) to align the printer plane and the vertical panel plane to be parallel.

The embodiment of the cuboid shaped object inkjet printing device may preferably move the UV inkjet head module progressively in the first direction (X) while jetting an at least partial image of the image, more preferably also move the UV inkjet head progressively in the second direction (Y) while jetting an at least partial image of the image and most preferably move the UV inkjet head module progressively in the opposite of the first direction (X) and/or second direction (Y) while jetting an at least partial image of the image if the cuboid shaped object inkjet printing device is constructed as multi-pass inkjet printing device.

The first direction (X) in the embodiment of the cuboid shaped object inkjet printing device is preferably a horizontal direction, preferably a vertical direction and more preferably a down-top direction to avoid dripping of the ink from the vertical panel before curing.

The UV inkjet head module in the embodiment of the cuboid shaped object inkjet printing device may preferably comprise for each ink of the set of UV curable ink to be jetted at least a part of a nozzle row which is parallel with the second direction (Y).

The UV inkjet head module in the embodiment of the cuboid shaped object inkjet printing device, if printing on a corrugated vertical panel, may rotate by a rotating device, in the plane formed by the second direction (Y) and the third direction (Z) so part of an nozzle row becomes parallel with the part of the corrugated panel before jetting a partial image of the image. The rotating device is attached to the base.

Another preferred embodiment of the cuboid shaped object inkjet printing device comprises the UV inkjet head module wherein 2 parts of nozzle rows and/or 2 parts of a curing device may be rotated, by the rotating device, in the plane formed by the second direction (Y) and the third direction (Z) so each nozzle becomes parallel with the part of the corrugated panel before jetting a partial image of the image. The rotating device in this preferred embodiment is attached to the UV inkjet head module.

The cuboid shaped object printer of the embodiment may comprise an emission module, attached to the base to reduce ink and/or gas emission from the UV inkjet head module.

The method of manufacturing a cuboid shaped intermodal freight container may comprise the UV curable inkjet printing method of the embodiment.

An automatic production line for manufacturing a cuboid intermodal freight container may comprise the cuboid shaped object inkjet printing device of the embodiment. A spray room, also called spray booth, to paint a cuboid intermodal freight container may comprise the cuboid shaped object inkjet printing device of the embodiment to jet the image after the painting of the cuboid intermodal freight container. Preferably the distance of the cuboid shaped object and the inkjet printing device while jetting is smaller than 2 meter and more preferably smaller than 1.5 meter because the space in a spray room to paint a cuboid intermodal freight container at both sides of the cuboid intermodal freight container is less than 2 meter.

The rotating device, linear movement devices, and movement device used in the embodiment of the cuboid shaped object printing for moving the UV Inkjet head module in several directions may be a printing bridge, telescopic arm and/or multiaxis application robot.

A preferred embodiment of the UV curable inkjet printing method comprises the step of jetting a colour-less ink or the ink of the same colour as the background of the vertical panel prior jetting at least a partial image to prevent dripping of the following jetted inks from the vertical panel. This anti-drip method is preferable jetting the colour-less ink at the boarders of the image and more preferable at the edges of the image which may be calculated with edge detection algorithms on the image and most preferable jetting the colour-less ink or the same colour as the background of the vertical panel prior jetting high coverage ink larger than 175% or prior jetting more than 2 other inks. Preferably a rendering device may calculate the anti-drip image out the content of the image that need to be jetted by the colour-less ink or the ink of the same colour as the background of the vertical panel.

### Curing Devices

The jetted UV curable inkjet inks are cured by exposing them to actinic radiation, preferably by exposing them to ultraviolet radiation.

The curing device is preferably arranged in combination with the print head of the inkjet printing device, travelling therewith so that the curable ink is exposed to curing radiation very shortly after been jetted. In a preferred embodiment, the jetted UV curable ink is exposed to UV radiation within 10 to 800 ms for maximizing image quality.

In such an arrangement it can be difficult to provide a small enough radiation source connected to and travelling with the print head. Preferably UV LEDs can be used but they are usually not powerful to realize a full cure. Therefore, a static fixed radiation source may be employed, e.g. a source of curing UV-light, connected to the radiation source by a flexible radiation conductor such as a fibre optic bundle or an internally reflective flexible tube.

In a preferred embodiment, the curing device, such as one or more UV LEDs, is attached to print-head so that the curing device follows the corrugation of the vertical in the same manner as the printhead. The UV LEDs following the corrugations may have different intensities. Higher intensities can be used in deeper regions.

Alternatively, the actinic radiation may be supplied from a fixed source to the radiation head by an arrangement of mirrors including a mirror upon the print head.

The source of radiation may also be an elongated radiation source extending transversely across the printed substrate to be cured. It may be adjacent the transverse path of the print head so that the subsequent rows of images formed by the print head are passed, stepwise or continually, beneath that radiation source.

Any ultraviolet light source, as long as part of the emitted light can be absorbed by the photo-initiator or photo-initiator system, may be employed as a radiation source, such as, a high or low pressure mercury lamp, a cold cathode tube, a black light, an ultraviolet LED, an ultraviolet laser, and a flash light. Of these, the preferred source is one exhibiting a relatively long wavelength UV-contribution having a dominant wavelength of 300-400 nm. Specifically, a UV-A light source is preferred due to the reduced light scattering therewith resulting in more efficient interior curing.

UV radiation is generally classed as UV-A, UV-B, and UV-C as follows:
UV-A: 400 nm to 320 nm
UV-B: 320 nm to 290 nm
UV-C: 290 nm to 100 nm.

In a preferred embodiment, the inkjet printing device contains one or more UV LEDs with a wavelength larger than 360 nm, preferably one or more UV LEDs with a wavelength larger than 380 nm, and most preferably UV LEDs with a wavelength of about 395 nm.

Furthermore, it is possible to cure the image using, consecutively or simultaneously, two light sources of differing wavelength or luminance. For example, the first UV-source can be selected to be rich in UV-C, in particular in the range of 260 nm-200 nm. The second UV-source can then be rich in UV-A, e.g. a gallium-doped lamp, or a different lamp high in both UV-A and UV-B. The use of two UV-sources has been found to have advantages e.g. a fast curing speed and a high curing degree.

The curing device may include a final curing device. Such curing devices complete the UV curing of the inks, after a partial curing by e.g. the UV LEDs.

For facilitating curing, the inkjet printing device may include one or more oxygen depletion units. The oxygen depletion units place a blanket of nitrogen or other relatively inert gas (e.g. CO₂), with adjustable position and adjustable inert gas concentration, in order to reduce the oxygen concentration in the curing environment. Residual oxygen levels are usually maintained as low as 200 ppm, but are generally in the range of 200 ppm to 1200 ppm.

Since relatively large ink droplets (nanoliters instead of picoliters) are jetted compared to conventional graphic arts inkjet printing devices, to simultaneously improve curing speed and image quality an air knife may be used in combination with the print head. The air knife flattens the jetted ink droplet prior to UV curing, so that the ink dot on the vertical panel has a smaller thickness yet covering a larger surface area. The air knife may also be used to prevent the dripping of the jetted ink on the panel. Preferably the air knife creates a laminar flow pattern of pressurized air parallel with the plane formed by the second direction (Y) and the third direction (Z).

### Anti-Static Devices

To eliminate static charges on the vertical panel before jetting, the inkjet printing devices may comprise an anti-static device also called static-dischargers to have a better control on the fluid dynamics of the jetted ink and to prevent electro-static discharge on the electronics of the inkjet printing device such as the electronics of the inkjet heads.

The anti-static device is preferably arranged in combination with the print head of the inkjet printing device, travelling therewith so that the vertical panel is electric static discharged before jetting.

### Rendering Devices

To jet an image on a vertical plane of a cuboid shaped object, the image may be rendered by a rendering device to the resolution of the cuboid shaped object inkjet printing device and the colors of the set of UV inkjet inks of the cuboid shaped object inkjet printing device. The rendering device may be comprised in the cuboid shaped object inkjet printing device of the embodiment.

The content of an image is preferable defined in raster graphics format such as Portable Network Graphics (PNG), Tagged Image File Format (TIFF), Adobe Photoshop Document (PSD) or Joint Photographic Experts Group (JPEG) or bitmap (BMP) but more preferably in vector graphics format, also called line-work format, such as Scale Vector Graphics (SVG) and AutoCad Drawing Exchange Format (DXF) and most preferably a page description language (PDL) such as Postscript (PS) or Portable Document Format (PDF).

The content of an image may be stored and/or loaded as one or more files on a memory of a computer which may be comprised in the cuboid shaped object inkjet printing device. The embodiment of the inkjet printing method may comprise a method to load the content of an image to a memory of a computer.

The content of an image may be a element of a queue of print jobs that is generated from Variable-data printing (VDP), also known as variable-information printing which is a form of digital printing, including on-demand printing, in which elements such as text, graphics and images may be changed from one printed piece to the next, without stopping or slowing down the printing process and using information from a database or external file.

If the content of an image is defined in a vector graphics format or page description language, the rendering device converting the content of the image to a raster graphics. The method of converting is called rastering and the rendering device is also called a raster image processor (RIP).

The rendering device may render the image in smaller sized sub-images also called partial images e.g. to reduce the amount of memory-use in the rendering device. The inkjet head printing device may jet the smaller sized sub-images one after each other on the vertical plane of the cuboid shaped object. To mask overlap at the edges of the jetted smaller sized sub-images stitch-algorithms, as exemplified in US 20040028291 (AGFA-GEVAERT), may be processed while rendering the image in smaller sized sub-images.

In a multi-pass printing method of the embodiment of the UV curable inkjet method the smaller sized sub-images may be defined by a print-mask and preferably by an anti-drip print-mask.

The rendering device may render parts of the image that have to be repaired or to be restored for an image on the vertical panel.

A preferred embodiment of the method of UV curable inkjet printing wherein the vertical panel is a corrugated panel comprising the step of compensating an anamorphic distortion of the image while rendering an image. This compensation may be calculated out a content of a 3D-image that defines the corrugation of the vertical panel. Preferably the content of the three-dimensional image is defined in a three-dimensional vector graphics format.

It was found that in the inclinations and/or edges of the relief of the vertical panel the jetted ink may flow together or flow away. This causes density and colour differences in the image that may be compensated while rendering the image.

### REFERENCE SIGNS LIST

TABLE 1

| | |
|---|---|
| 1 | standard container |
| 2 | reefer |
| 3 | open-top container |
| 4 | refrigeration unit |
| 5 | open-top |
| 6 | container skeleton |
| 7 | top side rail |
| 8 | top end rail |
| 9 | corner fitting |
| 10 | corner post |
| 11 | bottom end rail |
| 12 | bottom side rail |
| 13 | forklift pocket |
| 14 | cross member |
| 15 | roof panel |
| 16 | sidewall panel |
| 17 | marking panel |
| 18 | endwall panel |
| 19 | door assembly |
| 20 | rear end frame |
| 21 | treshold plate |
| 22 | ventilator |
| 23 | flooring |
| 24 | joint strip |
| 25 | truck |
| 26 | trailer |
| 27 | semi-trailer |
| 28 | boxcar |
| 29 | corrugated surface |
| 30 | rail |
| 31 | protrusion |
| 32 | print head in |
| | first position |
| 33 | print head in second position |
| 34 | UV curable ink droplet |
| 35 | active distance controller |
| 36 | individual printhead |
| 37 | print head array |
| 38 | horizontal step |
| 101 | cuboid shaped object |
| 102 | inkjet printhead module |
| 103 | vertical panel |
| 104 | nozz nozzle |
| 106 | droplet |
| 110 | base |
| 111 | printer bridge |
| 112 | multiaxis application robot |
| 113 | active distance controller |
| 120 | anti-static device |
| 122 | air-knife |
| 123 | curing device |

1-15. (canceled)

16. A method of UV curable inkjet printing on a vertical panel of an intermodal freight container, the method comprising the steps of:
jetting an image with a set of UV curable inks using an inkjet printing device including a base, an inkjet head, a first linear movement device, a second linear movement device, and an active distance controller, by moving the inkjet head in a first direction with the first linear movement device and moving the inkjet head in a second direction, perpendicular to the first direction, with the second linear movement device;
measuring a perpendicular distance from the active distance controller to a vertical panel; and
aligning a printing plane, defined by the first direction and the second direction, and the vertical panel to be parallel based on a result of the step of measuring; wherein the jetting of the image includes multi-pass printing.

17. The method of UV curable inkjet printing according to claim 16, further comprising the step of:
top coating the image to provide protection against sea-water.

18. The method of UV curable inkjet printing according to claim 16, wherein the step of multi-pass printing step includes using a print mask to prevent dripping of the UV curable inks from the vertical panel.

19. The method of UV curable inkjet printing according to claim 16, wherein the vertical panel is a corrugated panel, and the method further comprises the step of:
compensating for an anamorphic distortion of the image while rendering the image.

20. The method of UV curable inkjet printing according to claim 16, wherein the first direction is a vertical direction so that the inkjet head moves from bottom to top.

21. The method of UV curable inkjet printing according to claim 16, further comprising the step of:
curing the UV curable inks by exposing the UV curable inks to ultraviolet radiation with UV LEDs that move in combination with the inkjet head.

22. The method of UV curable inkjet printing according to claim 16, wherein one or more of the UV curable inks of the set of UV curable inks includes a white ink.

23. The method of UV curable inkjet printing according to claim 16, further comprising the step of mixing the set of UV curable inks in an ink mixing station, wherein at least one of the UV curable inks of the set of UV curable inks is a spot colour having a colour selected from the group consisting of RAL 1033, RAL 2000, RAL 2002, RAL 2004, RAL 3003, RAL 3005, RAL 3009, RAL 5003, RAL 5010, RAL 5013, RAL 5015, RAL 6002, RAL 6005, RAL 6013, RAL 6017, RAL 6018, RAL 7000, RAL 7031, RAL 7035, RAL 7037, RAL 7038, RAL 8004, RAL 8012, and RAL 9010.

24. The method of UV curable inkjet printing according to claim 16, further comprising the step of:
eliminating static on the vertical panel before jetting the image with the set of UV curable inks.

25. The method of UV curable inkjet printing according to claim 16, further comprising the step of:
creating a laminar flow of pressured air parallel with the printing plane using an air knife.

26. The method of UV curable inkjet printing according to claim 16, wherein the inkjet head includes a valve-jet print head.
